(19) United States
(12) Patent Application Publication
(10) Pub. No.: US 2010/0017482 A1
(43) Pub. Date: Jan. 21, 2010

(54) METHOD AND SYSTEM FOR LOCATION AWARE ELECTRONIC COMMUNICATION

(75) Inventors: Sandro Piccinini, Rome (IT); Luigi Pichetti, Rome (IT); Marco Secchi, Rome (IT)

Correspondence Address: IBM - EU c/o Myers Andras Sherman LLP, 19900 MacArthur Blvd., Suite 1150, Irvine, CA, 92612, US

(73) Assignee: International Business Machines Corporation, Armonk, NY (US)

(21) Appl. No.: 12/175,384

(22) Filed: Jul. 17, 2008

(51) Int. Cl. G06F 15/16

(52) U.S. Cl. 709/206

(57) ABSTRACT

A method and system for location aware electronic communication. One implementation involves receiving an electronic communication at a receiving client, upon detecting that the communication includes location-based information, retrieving criteria for processing the communication from a location profile, and automatically processing the communication utilizing the retrieved criteria and the location-based information from the communication.

### BACKGROUND OF THE INVENTION

1. Field of the Invention

The present invention relates generally to message communication and in particular to electronic message communication.

2. Background Information

With the proliferation of electronic communication devices, many users communicate using electronic messages for multiple functions including information requests, task assignment and data exchange. At the same time, collaboration systems are often used to trigger information exchange using real time communication schemes. However, such communication methods do not take into account the location of the receiver of a communication.

### SUMMARY OF THE INVENTION

The invention provides a method and system for location aware electronic communication. One embodiment involves receiving an electronic communication at a receiving client, upon detecting that the communication includes location-based information, retrieving criteria for processing the communication from a location profile, and automatically processing the communication utilizing the retrieved criteria and the location-based information from the communication.

The location profile may include location information of the receiving client, and the location-based information may include location information of a sender of the communication. The communication may include one or more of: electronic mail, meeting request, calendar invitation, chat, instant message. Automatically processing the communication may further include triggering a software agent client that selectively processes the communication based on the location-based information according to the retrieved processing criteria. The location profile may be dynamically updated based on events that indicate location preference of a user of the recipient.

Other aspects and advantages of the present invention will become apparent from the following detailed description, which, when taken in conjunction with the drawings, illustrate by way of example the principles of the invention.

### BRIEF DESCRIPTION OF THE DRAWINGS

For a fuller understanding of the nature and advantages of the invention, as well as a preferred mode of use, reference should be made to the following detailed description read in conjunction with the accompanying drawings, in which:

FIG. 1 shows a functional block diagram of a system location aware electronic communication, according to an embodiment of the invention.

FIG. 2 shows a flowchart of a process for location aware electronic communication, according to an embodiment of the invention.

### DESCRIPTION OF THE PREFERRED EMBODIMENTS

The following description is made for the purpose of illustrating the general principles of the invention and is not meant to limit the inventive concepts claimed herein. Further, particular features described herein can be used in combination with other described features in each of the various possible combinations and permutations. Unless otherwise specifically defined herein, all terms are to be given their broadest possible interpretation including meanings implied from the specification as well as meanings understood by those skilled in the art and/or as defined in dictionaries, treatises, etc.

The invention provides a method and system for location aware electronic communication. One embodiment involves automatically managing communication messages at a receiver of the messages. A location aware electronic communication process takes into account location (e.g., geographical location, network location) of a receiver of a communication and enables processing of the communication accordingly. In one implementation, receivers of a communication may discard irrelevant communication directed to receivers of a specific location, interact with calendar entries that may be automatically managed, and manage time in time reading or canceling the communication.

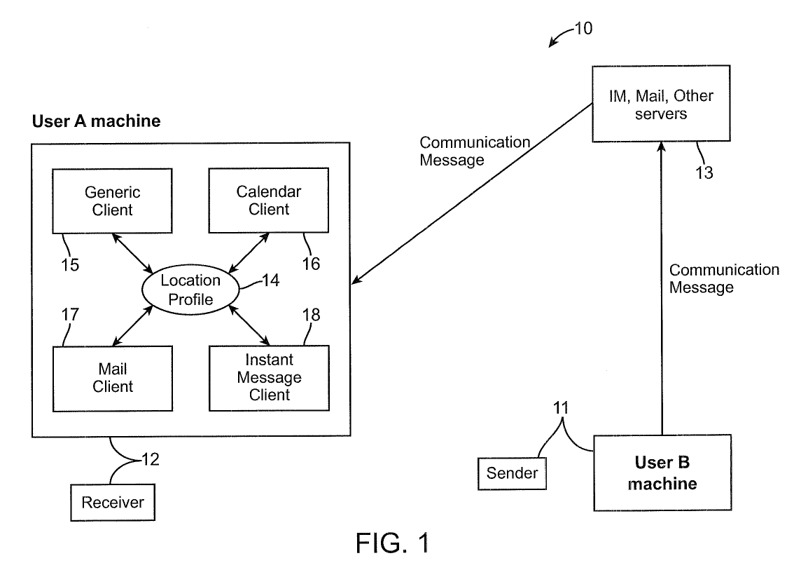

FIG. 1 shows a functional block diagram of a communication system 10 involving one or more senders 11 and one or more receivers 12. The senders 11 and receivers 12 may comprise electronic devices (e.g., consumer electronic devices, computers) having communication modules (e.g. email clients) configured for communicating electronic information such as messages via a communication system 13 (e.g., local area network, Internet, email servers).

A receiver 12 (e.g., User A machine) includes a specific location profile 14 comprising actions that may be triggered by each specific communication message based on the communication message details. The receiver 12 further includes a generic client 15, a calendar client 16, a mail client 17 and an instant message client 18.

The location profile 14 is leveraged (e.g., by mail client, collaboration system client) to improve receiver control over communications, to the satisfaction of a user of the receiver. Each user may define a location profile that describes the user's actual client main characteristics that can be used to trigger a set of pre-configured actions when a communication is received. Table 1 below shows an example location profile 14 which includes information about location of the corresponding receiver 12.

TABLE 1
Location Profile
Client Profile

| | |
|---|---|
| City | Rome |
| Location | Home |
| Time zone | GMT + 1 |
| Connection | ADSL 4 Mb |

The location profile 14 may include other information that provide enhanced capability for communication clients. For example, the profile may specify a building or floor or office of the user, allowing, for example, to not be disturbed in a meeting room. Another profile setting may be related to privacy such as alone in the office or currently in an open space or currently working with other people. This way the privacy of the location can affect the communication management. Further, the profile can be multiple or simply applied to a subset of communications,for example, profile A for instant messaging and profile B for mail and calendar.

Each client (e.g., clients 16-18) in a receiver with a location profile 14, may leverage the information in the location profile 14 (e.g., using a plug-in software module) to implement at the client side the desired actions that may be triggered by each location-based communication using the details in the location-based communication (e.g., location, time) and the information in the location profile 14.

In this manner, if a sender 11 desires to communicate an email to a receiver 12, the sender 11 can set the email with specific details (location-based) such that a mail client 17 (e.g., via an agent) at a receiver 12 that receives that email can perform a profiled action by leveraging information in its location profile 14, such as: Automatically set a received email as read and delete email, place a received email into an “automatically managed” folder, delete a received email, etc.

In another example, if the communication includes a calendar invitation (e.g., a meeting request), the calendar client 16 at receiver 12 may leverage the information in the location profile 14 for a set of predefined responses such as: Decline the invitation since the specified location in the communication is different from the location specified in the location profile 14 at the receiver 12, propose a new time since the specified time/time zone in the communication is different from the specified time/time zone in the location profile 14 at the receiver 12, automatically delegate the meeting request, etc.

In another example, if the communication from the sender 11 to the receiver 12 includes an instant message in an instant messaging system, the instant message client 18 of the receiver 12 may access the information location profile 14 at the receiver 12 for a specific status that allows the message client 18 to automatically manage the instant message. For example, in case a multipart chat is initiated by the instant message in setting up a lunch meeting with a remote worker (e.g., at a different geographical location), the user is not notified about the event.

An example operation scenario includes:

1. Receiver 12 (e.g., User A machine) sets a specific location profile 14.

2. Sender 11 (e.g., User B machine) sends a communication (e.g., email, chat) to the receiver 12, wherein the communication is location-based. This means the communication may specify e.g., a location, time/time zone.

3. The clients at the receiver 12 (e.g., clients 15-18 at User A) automatically manage the received communication using the location-based information in the communication and the information in the location profile 14.

4. Optionally one or more clients at the receiver 12 can check a log of all automatically managed communications to determine how communications have been automatically processed.

In one implementation, a user of a receiver 12 defines a location profile 14. A location aware application (e.g., generic client 15) at the receiver synchronizes with the location profile 14 at startup. A sender 11 sends a location-based communication to the receiver 12. The location aware application 12 receives the location-based communication and utilizes an agent therein (e.g., a plug-in module) to access and retrieve information from the location profile 14. The agent then triggers one or more of the calendar client 16, mail client 17, instant message client 18, to perform customized/automatic processing of the received communication utilizing the location-based information in the received communication and the information from the location profile 14. The automatic processing may be logged, and the user of the receiver 12 can check such operation log to determine how automatically managed communications have been processed.

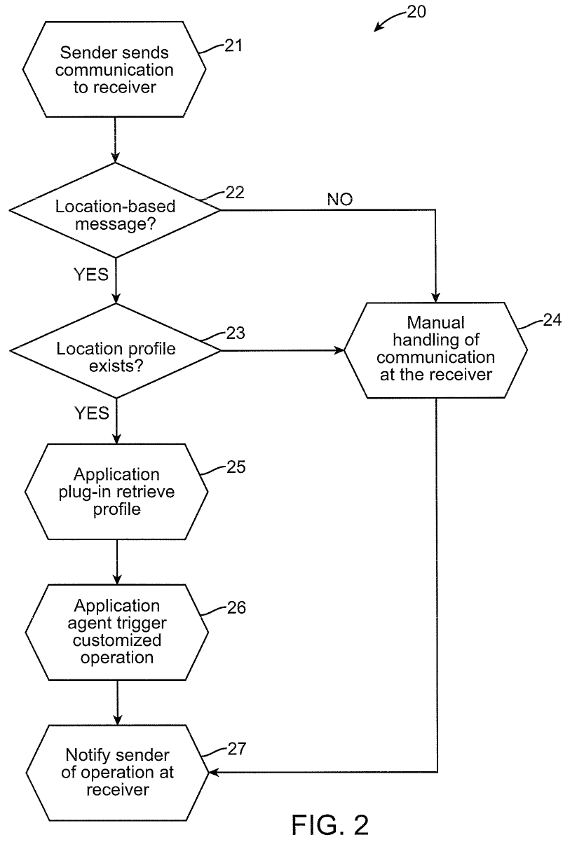

FIG. 2 shows a flowchart of a process 20 for location aware electronic communication in conjunction with the example system 10 in FIG. 1, according to an embodiment of the invention. At block 21, a sender 11 (User B, FIG. 1) sends a communication such as an email message to a receiver 12 (User A).

At block 22, it is determined if the received communication is a location-based communication. If not, then at block 24 the communication is forwarded for manual handling and the process proceeds to block 27. If the received communication is location-based, then at block 23 it is determined if a location profile 14 has been set up for the receiver 12. If not, then the process proceeds to block 24 for manual handling of the communication, otherwise the process proceeds to block 25.

At block 25, an application plug-in at the receiver retrieves the location profile 14. At process block 26, an application agent triggers customized/automatic processing of the received communication utilizing the location-based information in the received communication and the information from the location profile 14.

At process block 27 the process can optionally include notifying the sender 11 of the action taken on said communication by the receiver 12. The automatic management of the communication can be logged for user review. The process may then proceed back to block 22 to handle a next incoming communication.

The location profile 14 may be a part of a user profile that a user sets up at a receiver such as client of a communication system. Embodiments of the invention are based on profiles that are generic for different types of communications (e.g., email, instant messages, invitation requests, chats) and include a definition for a set of predefined management actions for a received location-based communication. The profile 14 may include different criteria that can be used for automatically handling different types of location-based communication (mail, chat), location and time/time zone, level of interest in the communication (To, cc, bcc), etc. Based on such criteria, a set of configurable actions are leveraged to automatically manage each type of location-based communication by interacting with the different agents (e.g., calendar, mail agents, chat).

The location profile can be dynamic, wherein it is adjusted essentially in real-time based on information beyond which was initially provided by a user. An example involves a location profile that leverages the information stored into the calendar to detect the working location for the user. If for example the user has some “accepted” meetings in a city different from the usual working location, the system can consequently manage the “location sensitive/sensible” messages/information.

As such, the location profile can be statically profiled for defining a working location into the profile, or dynamically adjusted/updated (e.g., by the generic client 15) based on external information such as wireless cell or specific location of internet cables. Using the dynamic location identification the system can manage location-based communications in a more granular way, for example avoiding receiving a chat request when the receiver is in a meeting room or generically outside an employee office. Further, the location information for a profile can be determined using existing events such as a meeting accepted in a specific location, allowing forecasting location of users in the future. A detailed log of all automatically managed communication may also be available for a user.

As is known to those skilled in the art, the aforementioned example embodiments described above, according to the present invention, can be implemented in many ways, such as program instructions for execution by a processor, as software modules, as computer program product on computer readable media, as logic circuits, as silicon wafers, as integrated circuits, as application specific integrated circuits, as firmware, etc. Though the present invention has been described with reference to certain versions thereof; however, other versions are possible. Therefore, the spirit and scope of the appended claims should not be limited to the description of the preferred versions contained herein. Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method for location aware electronic communication, comprising:
receiving an electronic communication at a receiving client;
upon detecting that the communication includes location-based information, retrieving criteria for processing the communication from a location profile; and
automatically processing the communication utilizing the retrieved criteria and the location-based information from the communication.

2. The method of claim 1 wherein the location profile includes location information of the receiving client.

3. The method of claim 1 wherein the location-based information includes location information of a sender of the communication.

4. The method of claim 1 wherein the communication includes one or more of: electronic mail, meeting request, calendar invitation, chat, instant message.

5. The method of claim 1 further including: upon detecting that the communication does not include location-based information, providing the communication for manual handling.

6. The method of claim 1 wherein automatically processing the communication further includes triggering a software agent client that selectively processes the communication based on the location-based information according to the retrieved processing criteria.

7. The method of claim 1 further including maintaining a location profile and dynamically updating the location profile based on events that indicate location preference of a user of the recipient.

8. A location aware electronic communication system, comprising:
a sender module configured for sending a location-based communication over a communication link;
a receiving module configured for receiving an electronic communication from the sender module;
a client module configured for retrieving criteria for processing the received communication from a location profile; and
an agent module configured for automatically processing the communication utilizing the retrieved criteria and the location-based information from the communication.

9. The system of claim 8 wherein the location profile includes location information of the receiving client.

10. The system of claim 8 wherein the location-based information includes location information of a sender of the communication.

11. The system of claim 8 wherein the communication includes one or more of: electronic mail, meeting request, calendar invitation, chat, instant message.

12. The system of claim 8 wherein the client module is further configured for: detecting if the communication includes location-based information, upon detecting that the communication includes location-based information, retrieving criteria for processing the communication from a location profile, and upon detecting that the communication does not include location-based information, providing the communication for manual handling.

13. The system of claim 8 wherein the agent module is further configured for selectively processing the communication based on the location-based information according to the retrieved processing criteria.

14. The system of claim 8 wherein the client module is further configured for maintaining a location profile and dynamically updating the information in the location profile.

15. A computer program product for location aware electronic communication, comprising a computer usable medium including a computer readable program, wherein the computer readable program when executed on a computer causes the computer to:
receive an electronic communication at a receiving client;
upon detecting that the communication includes location-based information, retrieve criteria for processing the communication from a location profile; and
automatically process the communication utilizing the retrieved criteria and the location-based information from the communication.

16. The computer program product of claim 15 wherein the location profile includes location information of the receiving client.

17. The computer program product of claim 15 wherein the location-based information includes location information of a sender of the communication.

18. The computer program product of claim 15 wherein the communication includes one or more of: electronic mail, meeting request, calendar invitation, chat, instant message.

19. The computer program product of claim 15 wherein the leverage said class method further causes the computer to: for fields of an object type, for all class methods that have a return type and do not take parameters, derive a pseudo-field name from each class method name, execute the class method to obtain a pseudo-field value, and use the class method names and values as if they were the names and values of a regular field.

20. The computer program product of claim 15 wherein the computer program further causes the computer to:
maintain a location profile and dynamically update the location profile based on events that indicate location preference of a user of the recipient; and
selectively process the communication based on the location-based information according to the retrieved processing criteria.
